(19) United States
(12) Patent Application Publication
(10) Pub. No.: US 2016/0032645 A1
(43) Pub. Date: Feb. 4, 2016

(54) ADJUSTABLE CORD LOCKER AND WINDOW BLIND HAVING SUCH ADJUSTABLE CORD LOCKER

(71) Applicant: NIEN MADE ENTERPRISE CO., LTD., Taichung (TW)

(72) Inventors: YU-CHE WEN, Taoyuan (TW); CHAO-HUNG NIEN, Taichung (TW); XU-WU QU, Taichung (TW)

(21) Appl. No.: 14/447,887

(22) Filed: Jul. 31, 2014

(51) Int. Cl. E06B 9/324

(52) U.S. Cl. CPC E06B 9/324

(57) ABSTRACT

An adjustable cord locker for fastening at least a lift cord to a bottom rail and regulating a length of the lift cord includes a barrel, a reel, and a control wheel. The reel is received in the barrel for rotation by control. The lift cord is inserted into the barrel and fastened to the reel to be wound around the reel when the reel is turning. The control wheel is connected to the reel for a user to operate to turn the reel. The control wheel is provided with teeth, and the barrel is provided with a pawl. The pawl is engaged with the teeth to allow the control wheel to be turned or hold still.

### BACKGROUND OF THE INVENTION

1. Technical Field

The present invention relates generally to window covering, and more particularly to an adjustable cord locker, and a window blind equipped with the adjustable cord locker.

2. Description of Related Art

Typically, a conventional window blind is provided with a headrail, a bottom rail, and a plurality of slats between the headrail and the bottom rail. The slats are connected to the headrail and the bottom rail through ladder cords and lift cords. The ladder cords controls tilt of the slats, and the lift cord controls the bottom rail to lift and lower.

The ladder cords and the lift cords will be lengthened while the ladder cords and the lift cords are working under tensions for a long time. Once the ladder cords are lengthened, a distance between the headrail and the bottom rail increases, and the slats might tilt from the normal. U.S. 2009/0294076 application provides a window blind, in which a cord locker is provided. The cord locker is provided with a turnable reel to wind the ladder cords therearound once the ladder cords are lengthened. However, this invention is unable to fix the problem of extension of the lift cord. As a result, the slats tilt for a large angle because of the tension and the length of the lift cord are different from that of the ladder cords.

### BRIEF SUMMARY OF THE INVENTION

In view of the above, the primary objective of the present invention is to provide an adjustable cord locker and a window blind having the adjustable cord locker, which is able to regulate the length of the lift cord to balance the bottom rail.

In order to achieve the objective of the present invention, an adjustable cord locker includes a barrel; and a reel received in the barrel for rotation by control, wherein a lift cord is fastened to the reel to wind the lift cord around the reel while the reel is rotated.

The present invention further provides a window blind, including a headrail; a bottom rail; a plurality of slats between the headrail and a bottom rail; and at least a lift cord passing through the headrail and the slats in sequence, and connected to the bottom rail through an adjustable cord locker. The adjustable cord locker includes a barrel; and a reel received in the barrel for rotation, wherein the lift cord is fastened to the reel to wind the lift cord around the reel while the reel is rotated.

Whereby, the length of the lift cord could be regulated by turning the reel to balance the bottom rail.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the window blind of a first preferred embodiment of the present invention;

FIG. 2 and FIG. 3 are sectional views of the cord locker of the first preferred embodiment of the present invention;

FIG. 4 is a perspective view of the cord locker of the first preferred embodiment of the present invention;

FIG. 5 is a perspective view of the cord locker of a second preferred embodiment of the present invention;

FIG. 6 is an exploded view of the cord locker of the second preferred embodiment of the present invention;

FIG. 7 is a perspective view of the cord locker of the second preferred embodiment of the present invention, showing the control wheel being turned by a screwdriver;

FIG. 8 is an exploded view of the cord locker of a third preferred embodiment of the present invention;

FIG. 9 is a perspective view of the cord locker of the third preferred embodiment of the present invention;

FIG. 10 is a sectional view of the cord locker of the third preferred embodiment of the present invention, showing the control wheel at the first position;

FIG. 11 is a sectional view of the cord locker of the third preferred embodiment of the present invention, showing the control wheel at the second position;

FIG. 12 is a sectional view of the cord locker, showing the spring between the reel and the control wheel;

FIG. 13 is an exploded view of the cord locker, showing the polygonal barrel and the trapezoidal teeth on the control wheel; and

FIG. 14 is a perspective view of FIG. 13.

### DETAILED DESCRIPTION OF THE INVENTION

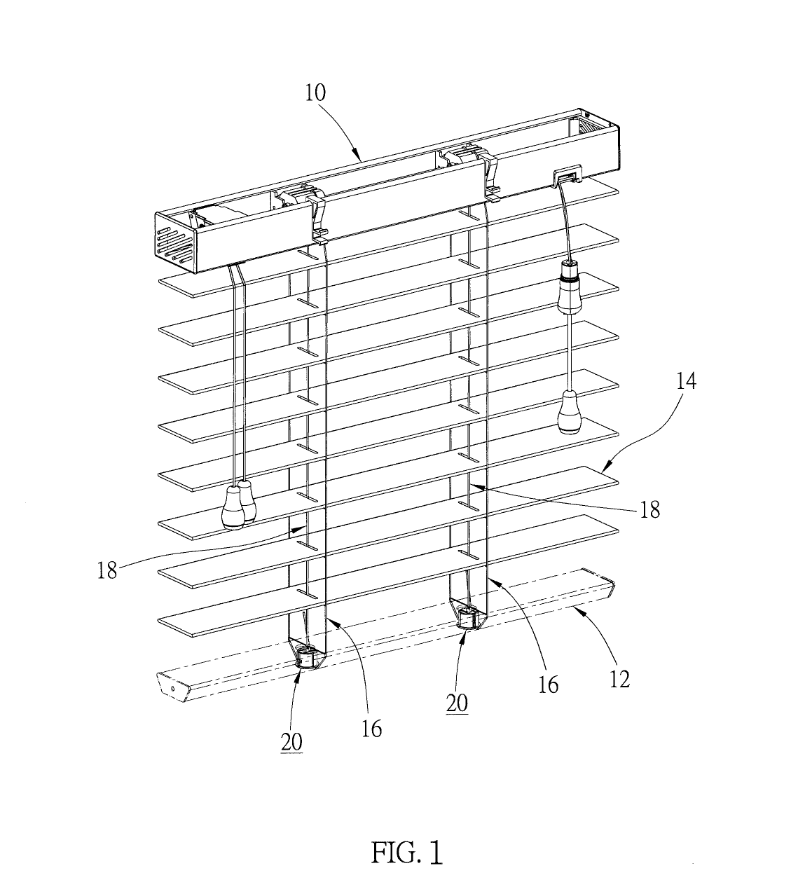

As shown in FIG. 1 to FIG. 4, a window blind 1, of the first preferred embodiment of the present invention includes a headrail 10, a bottom rail 12, and a plurality of slats 14 between the headrail 10 and the bottom rail 12. Two ladder cords 16 are connect to the headrail 10 and the bottom rail 12, and the slats 14 are spaced and supported by the ladder cords 16 between the headrail 10 and the bottom rail 12. A lift cord 18 has an end fastened to the bottom rail 12, passes through the slats 14 in sequence, goes into the headrail 10, and then goes out of the headrail 10 to beheld and operated by a user. The above elements and structure are the same as the conventional device, so we do not describe the detail here.

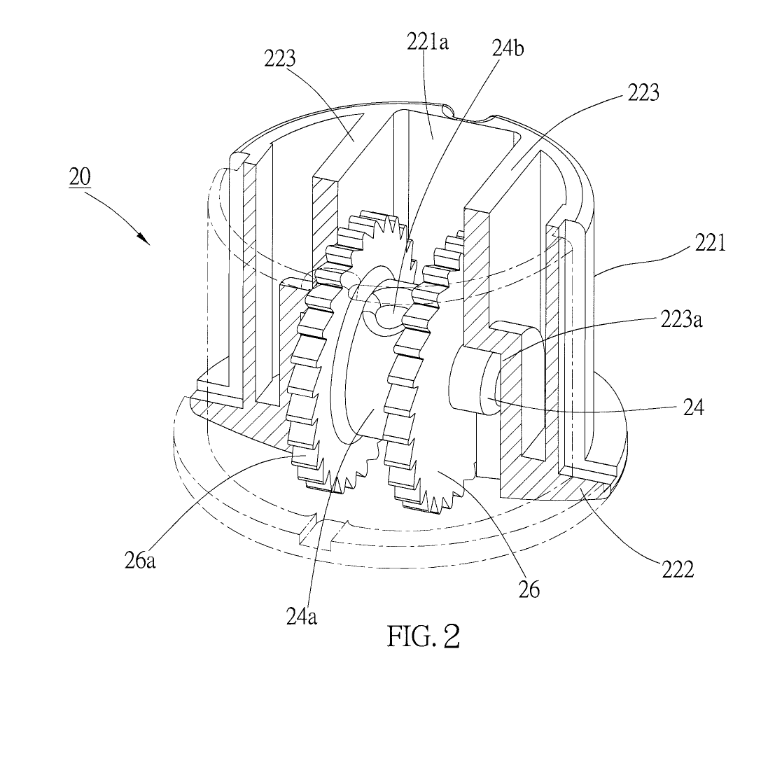

The window blind 1 further is provided with two adjustable cord lockers 20, which are received in bores on a bottom of the bottom rail 12. The lift cords 18 are fastened to the cord lockers 20 respectively to be connected to the bottom rail 12. In the present embodiment, each cord locker 20 has a barrel 22, a reel 24, and two control wheels 26. As shown in FIG. 2 to FIG. 4, the barrel 22 has a cylinder 221, a bottom board 222, two rib board 223, and two pawls 224. The cylinder 221 is hollow, and has a top opening 221a at a top thereof for the lift cord 18 passing through. The bottom board 222 is connected to a bottom of the cylinder 221, and has a bottom opening 222a. The bottom opening 222a is communicated with the top opening 221a. The rib boards 223 are parallel, and received in the cylinder 221. The rib boards 223 have opposite ends connected to the cylinder 221, and a bottom end connected to the bottom board 222. Each rib board 223 is provided with a slot 223a at a side facing each other. The bottom opening 222a is communicated with the slots 223a. The pawls 224 are two hooks projected from an inner side of the cylinder 221.

The reel 24 is a round rod having a cord portion 24a and a cord hole 24b on the cord portion 24a. The lift cord 18 passes through the cord hole 24b after the top opening 221a, and then is knotted. The lift cord 18 will be wound around the cord portion 24a while the reel 24 is turning. The reel 24 is transversely arranged in the cylinder 221 with opposite ends engaging the slots 223a of the rib boards 223, which means that the reel 24 is vertical to an axial direction of the barrel 22. The reel 24 is dragged by the lift cord 18, so that the reel 24 rests against top sidewalls of the slots 223a, and is turnable.

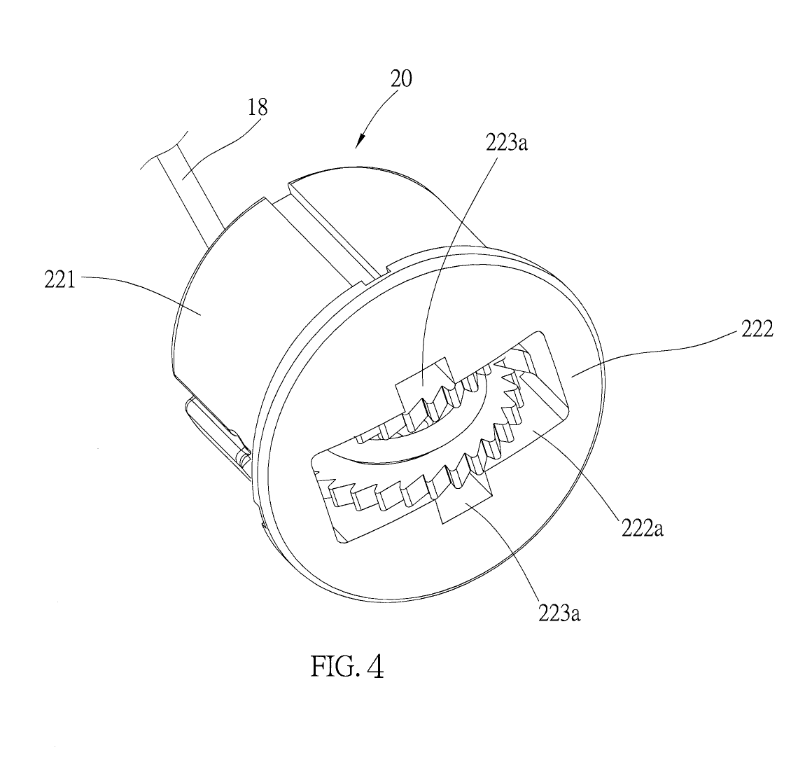

The control wheels 26 are fixed to the reel 24, and the cord portion 24a is between the control wheels 26. The reel 24 works like an axle of the control wheels 26. In the present embodiment, the control wheels 26 and the reel 24 are made into a single element. In another embodiment, the control wheels are two independent elements fixed to the reel. Each control wheel 26 has teeth 26a on a circumference thereof. In the present embodiment, the teeth 26a are ratchet teeth. As shown in FIG. 4, some of the teeth 26 extend out of the cylinder 221 via the bottom opening 222a to be operated by user to turn the reel 24.

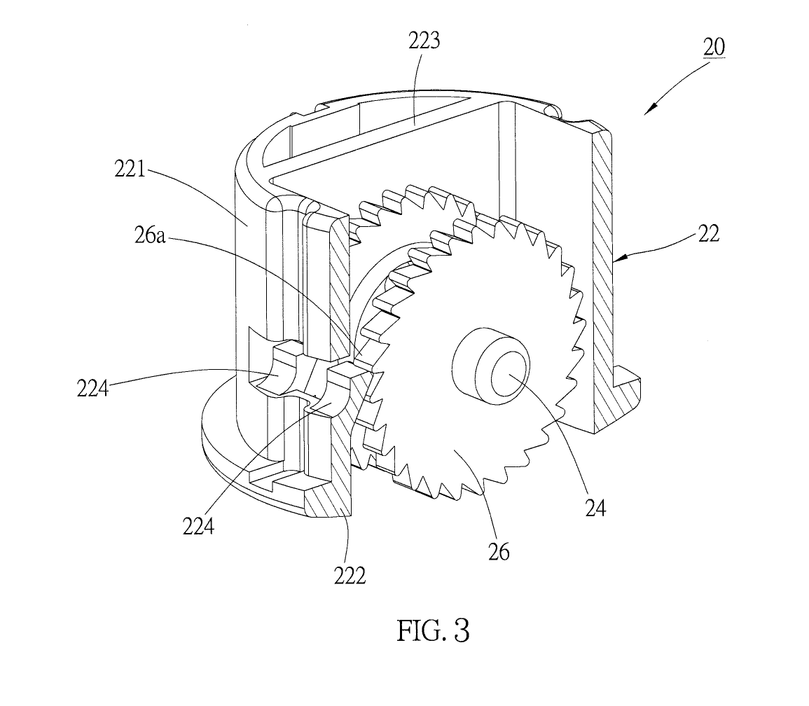

While one of the teeth 26a engaging the pawl 224, as shown in FIG. 3, the reel 24 stay still until one drives the control wheels 26. In other words, the cord locker 20 of the present invention may wind the lift cord 18 around the reel 24 in one direction to regulate the length change of the lift cord 18, and to balance the bottom rail 12.

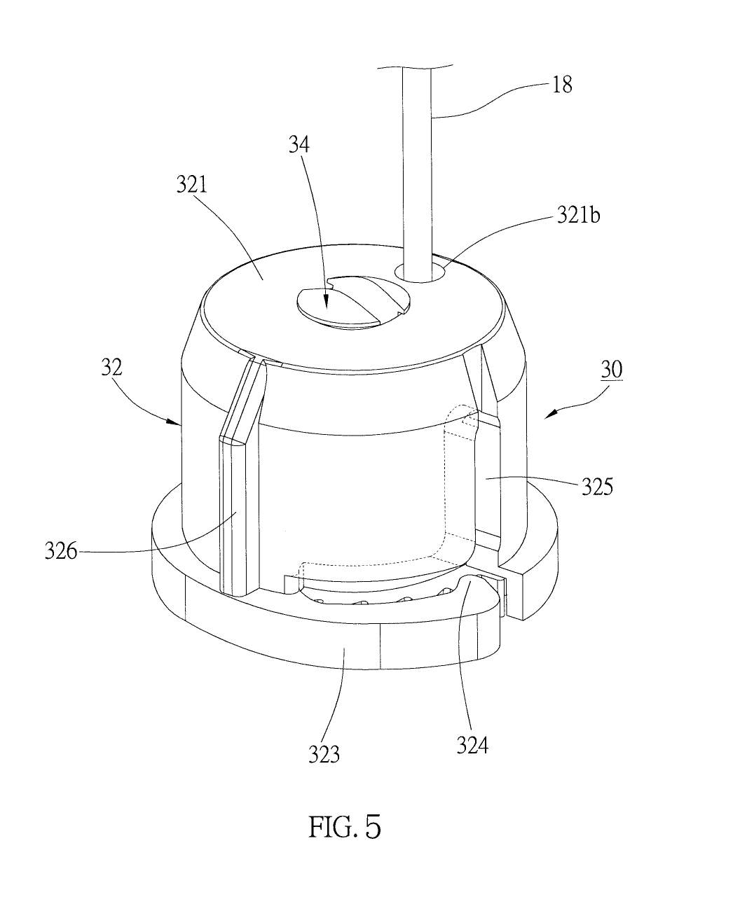

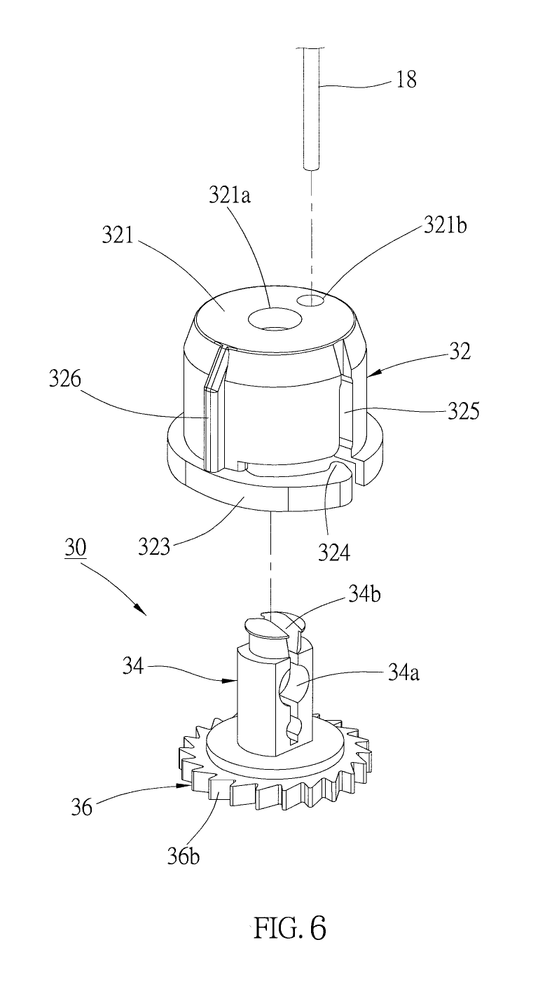

A cord locker 30 of the second preferred embodiment is shown in FIG. 5 to FIG. 7, which includes a barrel 32, a reel 34, and a control wheel 36. The different part of the cord locker 30 of the second preferred embodiment is that a top board 321 is connected to a top of the barrel 32. The top board 321 is provided with a bore 321a and a top opening 321b. A lift cord 18 is inserted into the top opening 321b. The barrel 32 is provided with a bottom opening 322 and a flexible arm 323 at a bottom thereof. The flexible arm 323 has a pawl 324, which is a protrusion, on an inner side and adjacent to a free end thereof.

The control wheel 36 is connected to an end of the reel 34. The reel 34 is vertical, parallel to the axial direction of the barrel 32, and inserted into the bore 321a via the bottom opening 322 while the control wheel 36 covers the bottom opening 322 of the barrel 32. The reel 34 has a cord hole 34a and a slot 34b. The cord hole 34a is radially passing through the reel 34, and the slot 34b breaks the reel 34 into two pieces from a free end, through the cord hole 34a, to a position adjacent to the control wheel 36. The reel 34 is provided with a recess at an end of the cord hole 34a, and the recess is larger than the cord hole 34a. At distal ends of the pieces of the reel 34 two hooks are provided. The hooks extend out of the bore 321a and hook an edge of the bore 321a that the reel 34 and the control wheel 36 will not escape from the barrel 32, but are turnable. The lift cord 18 is inserted into the top opening 321b, and then goes through the cord hole 34a via an end opposite to the recess, so that a knot of the lift cord 18 is received in the recess. As a result, the lift cord 18 is fastened to the reel 34, and wound around the reel 34 while the reel 34 is turning.

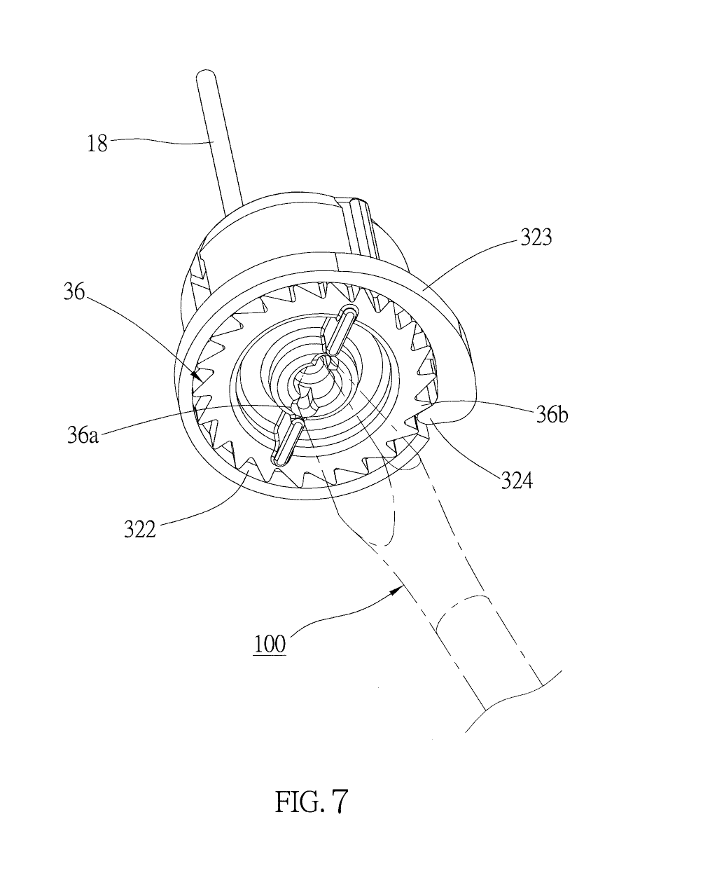

The control wheel 36 is provided with a driving portion 36a at a bottom thereof for an external force to engage to turn the control wheel 36, and the reel 34 will be turned at the same time to wind the lift cord 18. In the present embodiment, the driving portion 36a includes a straight slot for a screwdriver 100 (dot line in FIG. 7) to engage and turn the control wheel 36 by turning the screwdriver 100. The driving portion 36a further includes two protrusions at opposite ends of the straight slot for a user to hold them to turn the control wheel 36. The control wheel 36 is provided with ratchet teeth 36b on a circumference to be engaged with the pawl 324 that the reel 34 and the control wheel 36 are able to turn in one direction only. The function of the second preferred embodiment is the same as above, so we do not describe it again.

In addition to the top opening 321b, the barrel 32 is provided with two side openings 325 on an annular wall thereof. The lift cord 18 may be inserted into the barrel 32 through any of the side openings 325 instead of the top opening 321b to be fastened to the reel 34. Some window blinds are provided with two or more lift cords, and these lift cords do not pass through the slats. For this kind of lift cords, two of the lift cords could be inserted into the side openings 325 respectively to be fastened to the reel 34. The barrel 32 further is provided with several ribs 326 on the annular wall make the barrel 32 firmed engage the bore of the bottom rail 12.

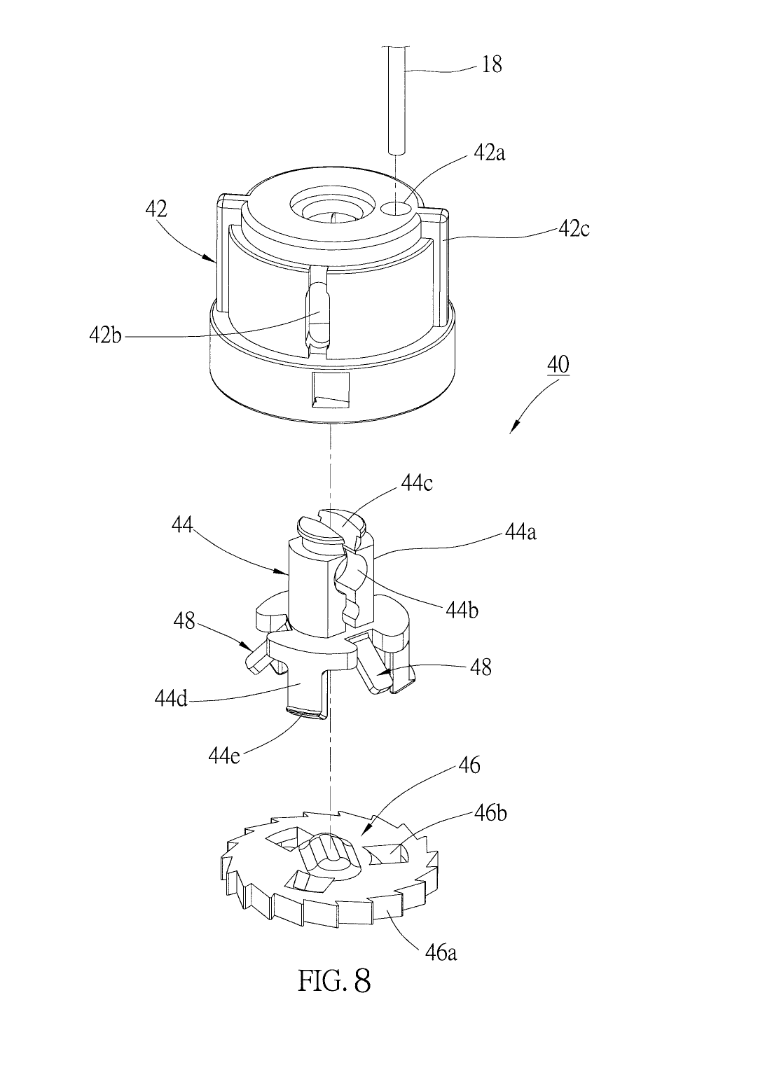

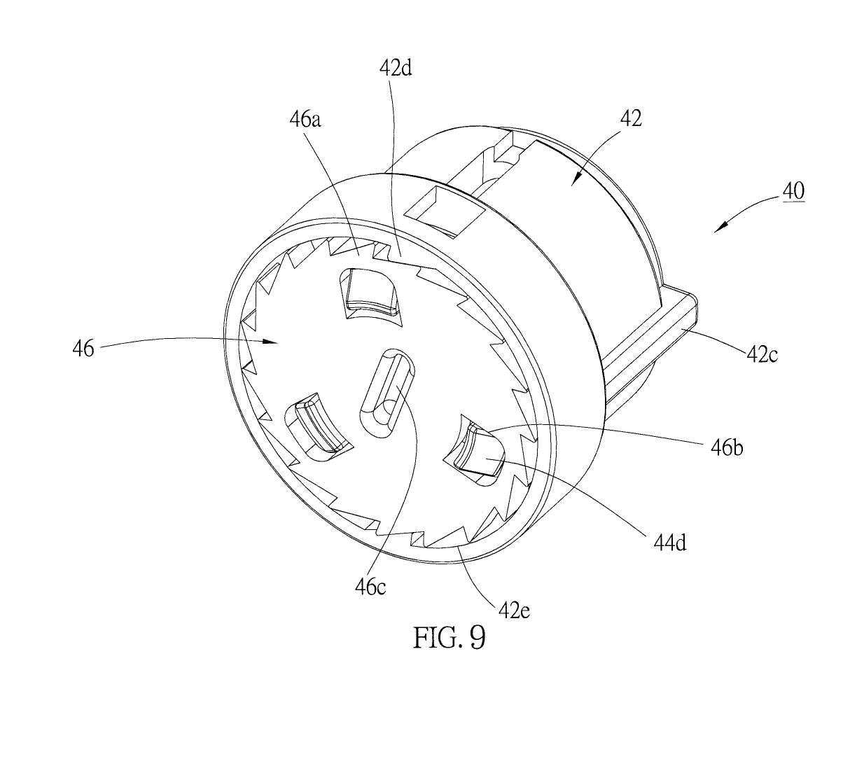

FIG. 8 and FIG. 9 show a cord locker 40 of the third preferred embodiment of the present invention, which includes a barrel 42, a reel 44, and a control wheel 46. The barrel 42 has a top opening 42a on a top and two side openings 42b on an annular wall for the lift cord 18 to be inserted into the barrel 42 through any of them. The same as above, the reel 44 has a cord hole 44b, a recess at an end of the cord hole 44b, and a slot 44c breaking the reel 44 into two pieces. The barrel 42 also has ribs 42c to make the barrel 42 firmly engage the bottom rail 12. The different part of the third embodiment is that a pawl 42d is not on a flexible arm, it's on an inner side of the barrel 42 and adjacent to a bottom opening 42e thereof.

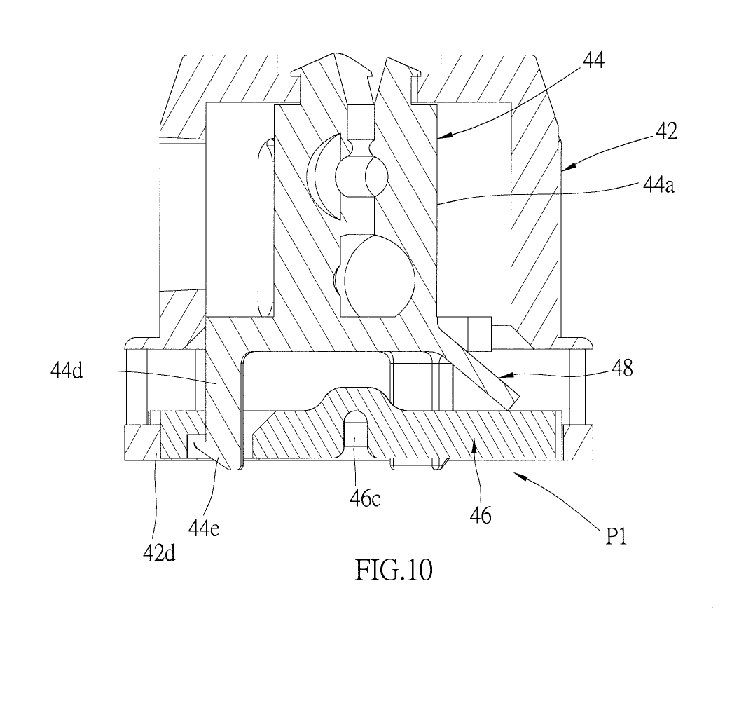

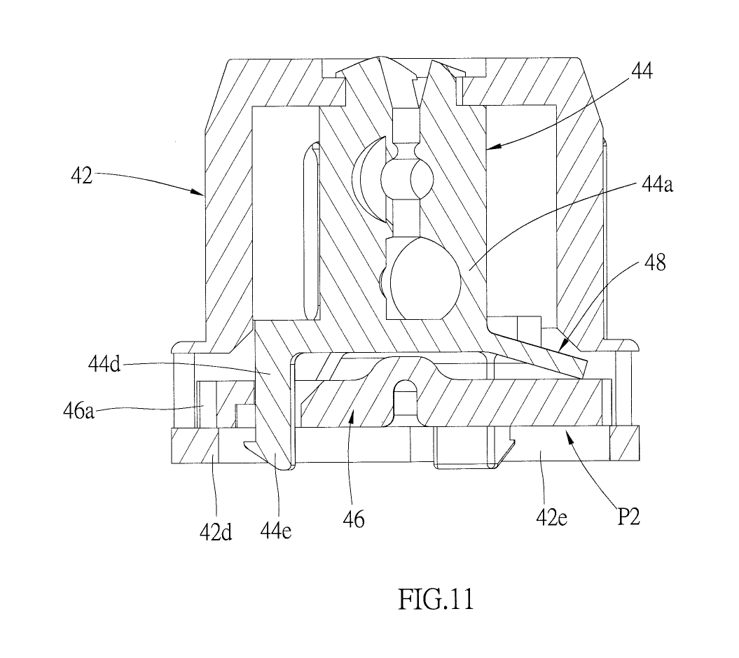

The reel 44 is connected to the control wheel 46, and both of them are received in the barrel 42. The control wheel 46 is provided with ratchet teeth 46a to be engaged with the pawl 42a to secure the control wheel 46 as well as the reel 44 while they are engaged. The reel 44 is provided with legs 44d projected from a bottom of a cord portion 44a, and each leg 44d is provided with a hook 44e at a distal end thereof. The control wheel 46 is provided with through holes 46b and a driving portion 46c (the straight slot). The legs 44d are inserted into the through hole 46b of the control wheel 46 respectively, and the hooks 44e extend out of the through hole 46b and engage an edge of the through hole 46b to make the control wheel 46 is able to move related to the reel 44 between a first position P1 (FIG. 10) and a second position P2 (FIG. 11). At the first position P1 the control wheel 46 keeps a distance from the reel 44, and the control wheel 46 moves towards the reel 44 while it move to the second position P2. In other words, the control wheel 46 at the second position P2 is closer to the reel 44 than the control wheel 46 at the first position P1. Furthermore, at the first position P1 the pawl 42d engages teeth 46a of the control wheel 46, and the pawl 42d disengages the teeth 46a when the control wheel 46 is moved to the second position P2.

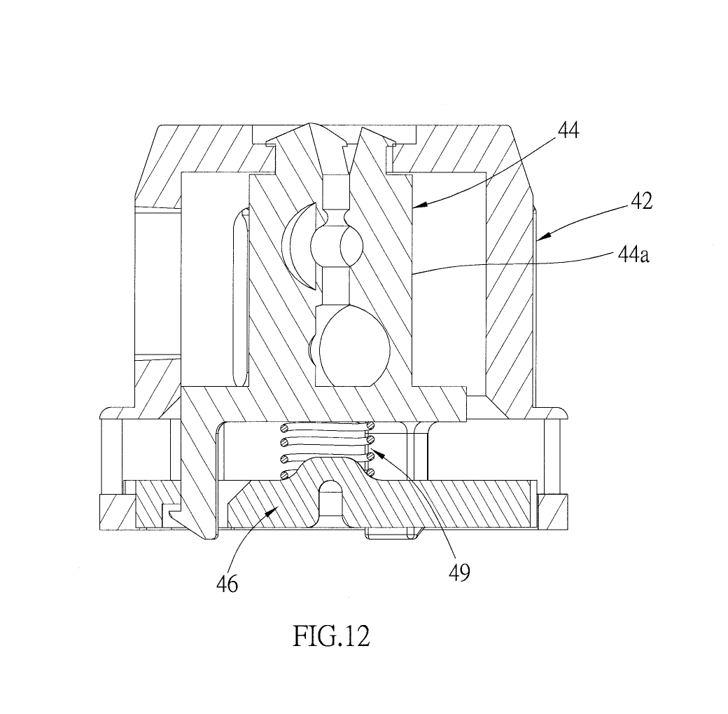

The cord locker 40 further is provide with at least an elastic member between the reel 44 and the control wheel 46 to urge the control wheel 46 toward the first position P1. The control wheel 46 will be stopped at the first position P1 because of the hooks 44e of the legs 44. In the present embodiment, the elastic member includes several flexible pieces 48 projected from the reel 42. Distal ends of the flexible pieces 48 touch and urge the control wheel 46 toward the first position P1. An alternate elastic member is shown in FIG. 12, which is a spring 49 with opposite end urging the reel 44 and the control wheel 46. They achieve the same function.

While a user wants to regulate a length of the lift cord 18, he/she engages a screwdriver with the driving portion 46c of the control wheel 46, and pushes the control wheel 46 to the second position P2. At this time, the control wheel 46 is free to turn, and the user may turn the control wheel 46 in both directions to shorten or lengthen the lift cord 18. After regulation, he/she only has to release, and the elastic member will move the control wheel 46 back to the first position P1 right away to secure the reel 44 again.

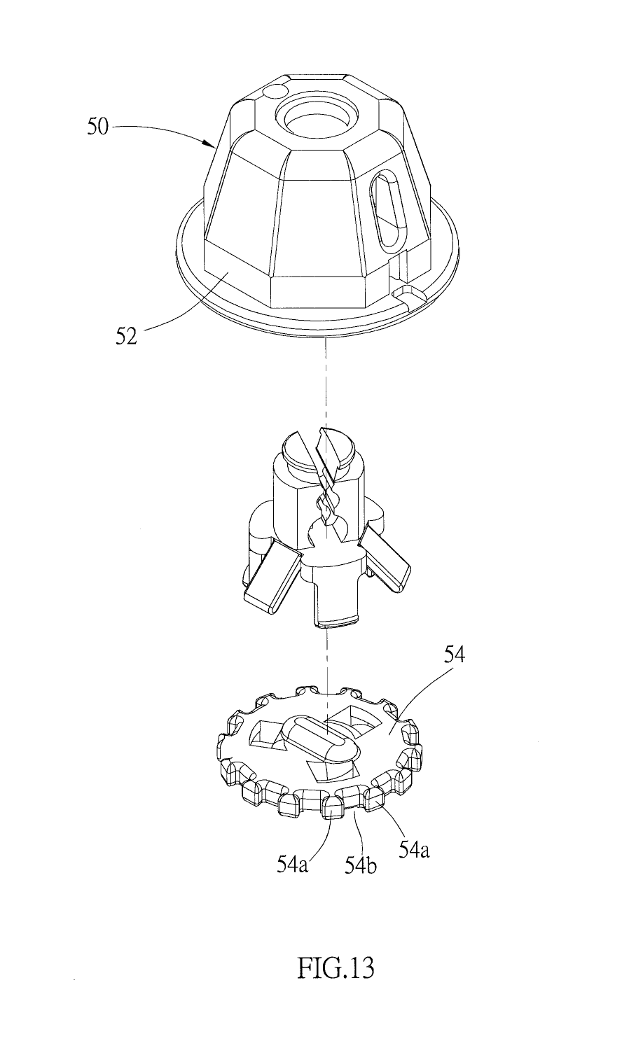

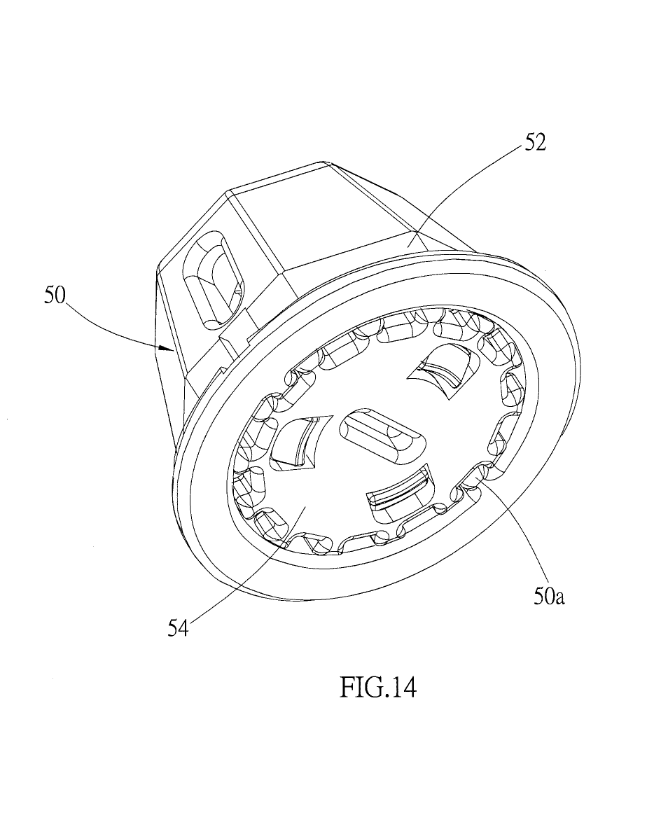

FIG. 13 shows a barrel 50, which has a polygonal cylinder 52 instead of the round cylinder as described above. The polygonal cylinder 52 may make the barrel 50 much firmly engage the bottom rail 13. FIG. 13 and FIG. 14 show an alternate design of teeth of the control wheel 54. The teeth 54a of the control wheel 54 are trapezoidal teeth, and recesses 54b between the trapezoidal teeth 54a are complementary to the pawl 50a for engagement.

It must be pointed out that the embodiments described above are only some preferred embodiments of the present invention. All equivalent methods which employ the concepts disclosed in this specification and the appended claims should fall within the scope of the present invention.

What is claimed is:

1. An adjustable cord locker, comprising:
a barrel; and
a reel received in the barrel for rotation by control, wherein at least a lift cord is fastened to the reel to be wound around the reel while the reel is being rotated.

2. The adjustable cord locker of claim 1, further comprising a control wheel connected to the reel, wherein the barrel has a top opening, a bottom opening communicated with the top opening, and a pawl provided therein; the control wheel is provided with teeth to be engaged with the pawl to hold the reel still.

3. The adjustable cord locker of claim 2, wherein the teeth of the control wheel are ratchet teeth which allow the control wheel to rotate in one direction only.

4. The adjustable cord locker of claim 3, wherein the reel is substantially vertical to an axial direction of the barrel, and some of the teeth of the control wheel extend out of the barrel through the bottom opening.

5. The adjustable cord locker of claim 3, wherein the reel is substantially parallel to an axial direction of the barrel, and the control wheel is connected to an end of the reel to cover the bottom opening of the barrel.

6. The adjustable cord locker of claim 5, wherein the barrel is provided with a flexible arm, on which the pawl is provided.

7. The adjustable cord locker of claim 5, wherein the control wheel has a through hole; the reel has a cord portion and a leg; the lift cord is wound on the cord portion; the leg is inserted into the through hole of the control wheel to make the control wheel move along the leg between a first position and a second position; the pawl is engaged with the teeth of the control wheel when the control wheel is moved to the first position, and the pawl is disengaged with the teeth of the control wheel when the control wheel is moved to the second position.

8. The adjustable cord locker of claim 7, further comprising an elastic member between the reel and the control wheel to urge the control wheel toward the first position.

9. The adjustable cord locker of claim 5, wherein the barrel is provided with a top board, on which the top opening is provided; the top board further has a bore, and the reel has an end engaged with the bore; the control wheel is provided with a driving portion for receiving an external force to turn the control wheel.

10. The adjustable cord locker of claim 9, wherein the reel is provided with a cord hole;
the lift cord passes through the top opening and the cord hole in sequence, and is knotted to fasten the lift cord to the reel.

11. The adjustable cord locker of claim 9, wherein the barrel is provided with a side opening on an annular wall thereof, and the reel is provided with a cord hole; the lift cord passes through the side opening and the cord hole in sequence, and is knotted to fasten the lift cord to the reel.

12. A window blind, comprising:
a headrail;
a bottom rail;
a plurality of slats between the headrail and a bottom rail; and
at least a lift cord passing through the headrail and the slats in sequence, and connected to the bottom rail through an adjustable cord locker, wherein the adjustable cord locker comprises:
a barrel; and
a reel received in the barrel for rotation, wherein the lift cord is fastened to the reel to be wound around the reel while the reel is being rotated.

13. The adjustable cord locker of claim 12, further comprising a control wheel connected to the reel, wherein the barrel has a top opening, a bottom opening communicated with the top opening, and a pawl provided therein; the control wheel is provided with teeth to be engaged with the pawl to hold the reel still.

14. The adjustable cord locker of claim 13, wherein the teeth of the control wheel are ratchet teeth which allow the control wheel to rotate in one direction only.

15. The adjustable cord locker of claim 14, wherein the reel is vertical to an axial direction of the barrel, and some of the teeth of the control wheel extend out of the barrel through the bottom opening.

16. The adjustable cord locker of claim 14, wherein the reel is parallel to an axial direction of the barrel, and the control wheel is connected to an end of the reel to cover the bottom opening of the barrel.

17. The adjustable cord locker of claim 16, wherein the barrel is provided with a flexible arm, on which the pawl is provided.

18. The adjustable cord locker of claim 16, wherein the control wheel has a through hole; the reel has a cord portion and a leg; the lift cord is wound on the cord portion; the leg is inserted into the through hole of the control wheel to make the control wheel move along the leg between a first position and a second position; the pawl is engaged with the teeth of the control wheel when the control wheel is moved to the first position, and the pawl is disengaged with the teeth of the control wheel when the control wheel is moved to the second position.

19. The adjustable cord locker of claim 18, further comprising an elastic member between the reel and the control wheel to urge the control wheel toward the first position.

20. The adjustable cord locker of claim 16, wherein the barrel is provided with a top board, on which the top opening is provided; the top board further has a bore, and the reel has an end engaged with the bore; the control wheel is provided with a driving portion for receiving an external force to turn the control wheel.

21. The adjustable cord locker of claim 20, wherein the reel is provided with a cord hole; the lift cord passes through the top opening and the cord hole in sequence, and is knotted to fasten the lift cord to the reel.

22. The adjustable cord locker of claim 20, wherein the barrel is provided with a side opening on an annular wall thereof, and the reel is provided with a cord hole; the lift cord passes through the side opening and the cord hole in sequence, and is knotted to fasten the lift cord to the reel.
